(19) United States
(12) Patent Application Publication
(10) Pub. No.: US 2022/0250319 A1
(43) Pub. Date: Aug. 11, 2022

(54) ADDITIVE MANUFACTURING WITH LASER ARRAYS

(71) Applicant: Hewlett-Packard Development Company, L.P., Spring, TX (US)

(72) Inventors: Wei Huang, Palo Alto, CA (US); Gary J. Dispoto, Palo Alto, CA (US)

(73) Assignee: Hewlett-Packard Development Company, L.P., Spring, TX (US)

(21) Appl. No.: 17/415,171

(22) PCT Filed: Aug. 5, 2019
(86) PCT No.: PCT/US2019/045150

§ 371 Date: Jun. 17, 2021

(51) Int. Cl. B29C 64/277; B29C 64/153; B29C 64/205; B33Y 10/00; B33Y 30/00

(52) U.S. Cl. CPC B29C 64/277; B29C 64/153; B33Y 30/00; B33Y 10/00; B29C 64/205

(57) ABSTRACT

In one example in accordance with the present disclosure, an additive manufacturing device is described. The additive manufacturing device includes a build material distributor to deposit layers of powdered build material onto a bed. An agent distributor of the additive manufacturing device deposits at least one property-changing agent in a pattern onto a layer of powdered build material. The additive manufacturing device also includes an array of lasers to selectively fuse portions of the layer of powdered build material in a pattern.

### BACKGROUND

Additive manufacturing systems produce three-dimensional (3D) objects by building up layers of material. Some additive manufacturing systems are referred to as “3D printing devices” because they use inkjet or other printing technology to apply some of the manufacturing materials. 3D printing devices and other additive manufacturing devices make it possible to convert a computer-aided design (CAD) model or other digital representation of an object directly into the physical object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an additive manufacturing device with a laser array, according to an example of the principles described herein.

FIG. 2 is a simplified top view of an additive manufacturing system with a laser array, according to an example of the principles described herein.

FIG. 3 is a side view of an additive manufacturing device with a laser array, according to another example of the principles described herein.

FIG. 4 is an isometric view of the laser array over a build area of an additive manufacturing device, according to an example of the principles described herein.

FIG. 5 is a flow chart of a method for additive manufacturing with a laser array, according to an example of the principles described herein.

FIGS. 6A-6D depict additive manufacturing with laser arrays, according to an example of the principles described herein.

FIGS. 7A-7D depict additive manufacturing with laser arrays, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Additive manufacturing systems form a three-dimensional (3D) object through the solidification of layers of a build material. Additive manufacturing systems make objects based on data in a 3D model of the object generated, for example, with a computer-aided drafting (CAD) computer program product. The model data is processed into slices, each slice defining portions of a layer of build material that is to be solidified.

In one example, to form the 3D object, a build material, which may be powder, is deposited on a bed. A laser, or other power source is selectively aimed at the powdered build material, or a layer of the powdered build material. The emitted energy from the laser raises the temperature of the powdered build material, causing the portions under the influence of the laser to fuse together or solidify to form a slice of the 3D printed object.

While such additive manufacturing operations have greatly expanded manufacturing and development possibilities, further development may make 3D printing a part of even more industries. For example, it may be desirable to change properties of a 3D printed object. Examples of such properties that may be changed include a hardness, an elasticity, an electrical conductivity, a translucence, and a transparency. More specifically, it may be desirable to change these properties for just a portion of the 3D printed object. For example, for a 3D printed model of a car, it may be desirable to plasticize the tire portion of the model to more accurately replicate the material of an actual car tire.

Accordingly, the present specification describes a device, system, and method for forming multi-property 3D printed objects using inkjet agent distribution and laser sintering. Specifically, the present specification describes combining an array of lasers, rather than a single laser, with inkjet printing so that multi-property parts can be produced. According to the method, property-changing agents are printed on the powdered build material layer-by-layer at a voxel resolution to create a property distribution across a surface of the layer of the 3D printed object. For each layer, an array of lasers is used to fuse the powdered build material based on the geometry of the object. Such a fusing may be before or after the inkjetting. In these examples, the property-changing agents may be of a variety of types including, a plasticizer agent to change the mechanical properties of the powdered build material and a nano-silver agent to change the electrical properties of the powdered build material, etc. In a more general sense, the present application describes systems and methods that use inkjetting to change the physical properties of the powdered build material, properties such as mechanical properties, optical properties, and electrical properties, among others. In some examples, the optical property changed is other than a color of the powdered build material.

Specifically, the present specification describes an additive manufacturing device. The additive manufacturing device includes a build material distributor to deposit layers of powdered build material onto a bed. An agent distributor of the additive manufacturing device deposits at least one property-changing agent in a pattern onto a layer of powdered build material. The additive manufacturing device also includes an array of lasers to selectively fuse portions of the layer of powdered build material in a pattern.

The present specification also describes a method for forming a 3D printed object with a laser array. According to the method, a layer of powdered build material is deposited and at least one property-changing agent is deposited on the layer of powdered build material in a predetermined pattern. A portion of the layer of powdered build material is fused to form a slice of the 3D printed object. This is done by selectively activating a subset of lasers in an array of lasers.

The present specification also describes an additive manufacturing system. The additive manufacturing system includes an additive manufacturing device which includes a build material distributor to deposit layers of powdered build material onto a bed and multiple agent distributors to deposit multiple property-changing agents on layers of powdered build material in patterns. As described above, the additive manufacturing system also includes an array of lasers to selectively fuse portions of the layer of powdered build material in a pattern. The additive manufacturing system also includes a controller. The controller 1) controls the build material distributor to deposit layers of powdered build material, 2) controls the multiple agent distributors to deposit the multiple property-changing agents in their respective patterns on the layers of the powdered build material, and 3) controls the array of lasers to activate a subset of lasers which coincide with a slice of the 3D printed object.

Such systems and methods 1) provide for powder-based multi-property additive manufacturing, 2) change material properties at a per-voxel resolution, and 3) fuse individual layers of a 3D printed object. However, it is contemplated that the systems and methods disclosed herein may address other matters and deficiencies in a number of technical areas.

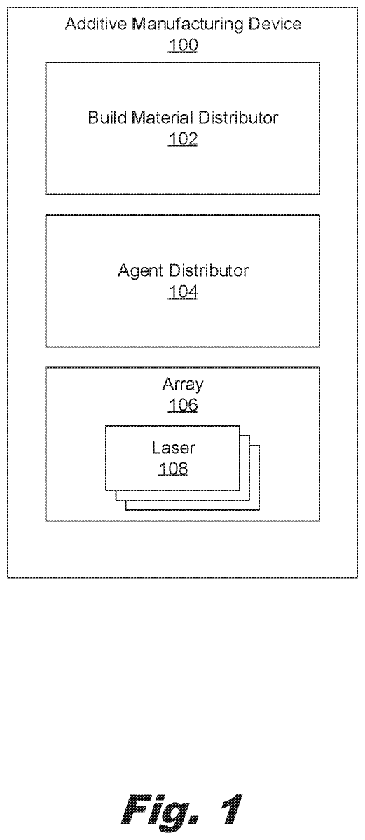

Turning now to the figures, FIG. 1 is a block diagram of an additive manufacturing device (100) with a laser array (106), according to an example of the principles described herein. As described above, a 3D printed object may be formed by selectively hardening powdered build material in particular patterns. In some examples, this may be done in a layer-wise fashion, wherein individual slices of a 3D printed object are formed. This process is repeated layer-by-layer until the 3D printed part is formed. In general, apparatuses for generating three-dimensional objects may be referred to as additive manufacturing devices (100). The additive manufacturing device (100) described herein may correspond to three-dimensional printing systems, which may also be referred to as three-dimensional printers.

In one example, the additive manufacturing device (100) includes a build material distributor (102) to successively deposit layers of the powdered build material onto a bed. Each layer of the powdered build material that is fused in the bed forms a slice of the 3D printed object such that multiple layers of fused build material form the entire 3D printed object.

The additive manufacturing device (100) also includes an agent distributor (104) to deposit at least one property-changing agent in a pattern onto a layer of powdered build material. As described above, the property-changing agent may change a variety of properties for all, or a portion of, the 3D printed object. For example, when generating a particular model of an object, it may be desirable that a portion of that object has an increased hardness. Accordingly, in this example, the agent distributor (104) may apply a liquid epoxy in a particular pattern that corresponds to the portion of the 3D printed object that is to have the increased hardness. As it ejects agent at a per-voxel level, the agent distributor (104) allows for high resolution and highly precise agent deposition such that areas of localized property changes may be highly localized and specific.

The property-changing agents that are deposited may be of a variety of types. In some examples, the agents may be defined by the property that they change. For example, the agent distributor (104) may deposit an electrical property-changing agent, a plasticizing agent, a hardening agent, a transparency property-changing agent, and a translucency property-changing agent. In some examples, the agent distributor (104) may deposit a property-changing agent that is other than a color changing agent and a colored ink. As specific examples, the property-changing agent may include nano-silver particles to increase an electrical conductivity of the powdered build material. In another example, a plasticizer may decrease Young's modulus and may increase strain at break. In yet another example, barium titanium oxide (BaTiO₄) may be added to increase the electrical resistance of the powdered build material. In a more general sense, the property-changing agent may change electrical, mechanical, and/or optical properties of the powdered build material on which it is deposited. In some examples, the optical property changed is other than a color of the powdered build material. In some examples, the agent that is deposited is free of fusing agent. A fusing agent may be a compound that causes the powdered build material to fuse together or otherwise solidify when exposed to a quantity of energy, such as from infrared light. Accordingly, in some examples, the agent does not take part in the operation of fusing the powdered build material particles together, and this fusing process is instead performed by the laser array (106).

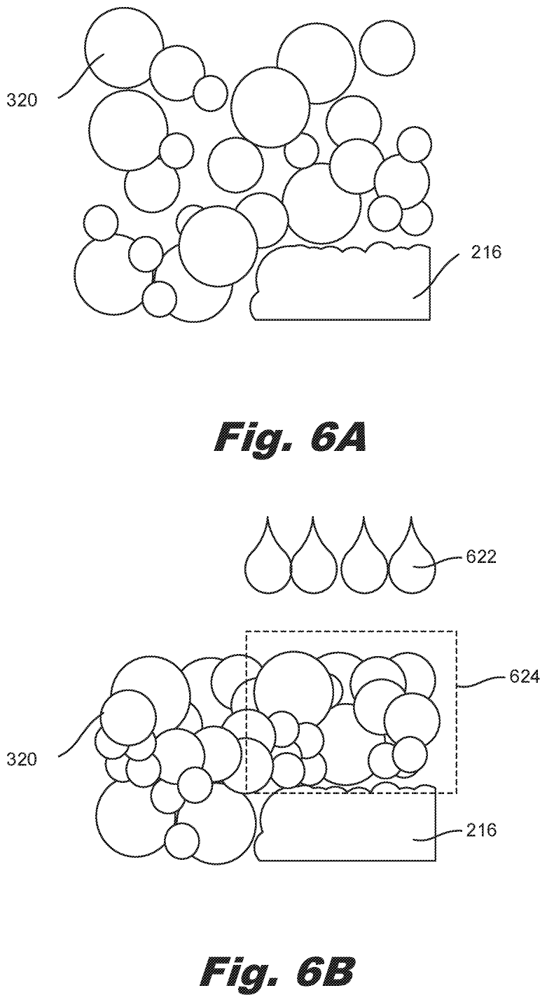

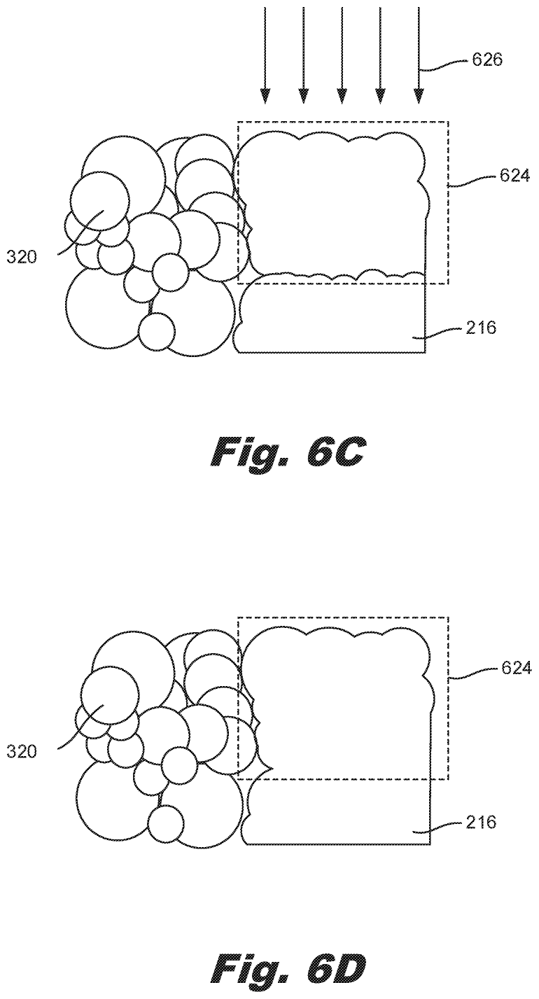

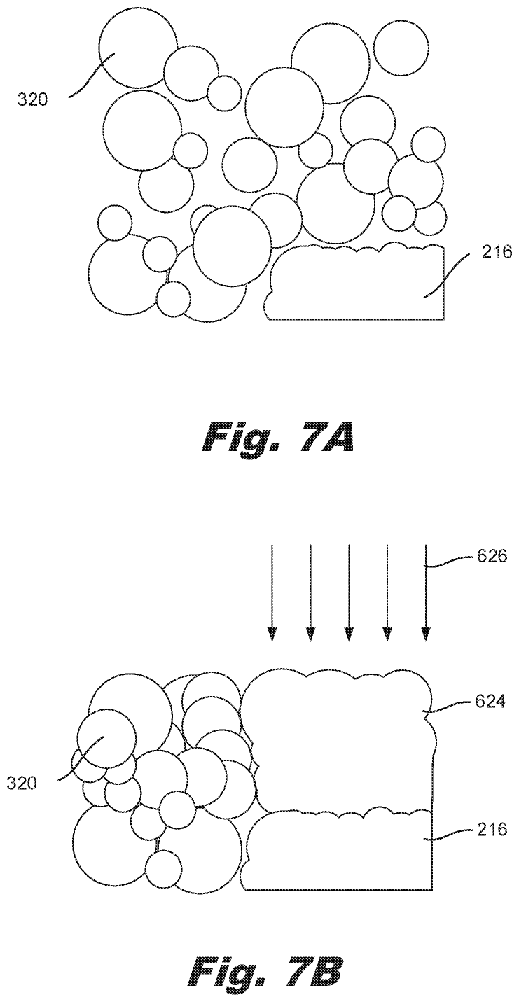

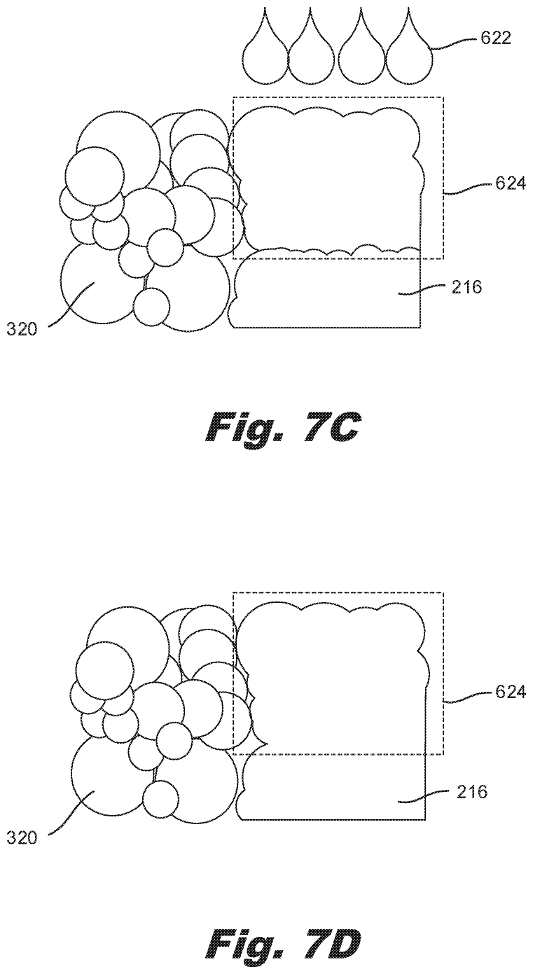

In some examples, the agent distributor (104) may deposit multiple property changing agents. In this example, the single agent distributor (104) is coupled to multiple agent reservoirs, each agent reservoir to hold a particular property-changing agent. As will be described below in connection with FIGS. 6A-7D, the agent distributor (104) may operate either before, after, or concurrently with the array (106) of lasers (108) which harden certain areas of the layers of powdered build material.

The additive manufacturing device (100) also includes an array (106) of lasers (108). As described above, the lasers (108) apply heat to the powdered build material which raises the temperature of voxels exposed to the energy of the lasers (108). As the temperature of the individual powdered build material particles raises, they partially or completely melt. Upon cooling, they harden together to form a solid body. Accordingly, after each layer of powdered build material is deposited, the lasers (108) are activated to selectively harden portions of the powdered build material that correspond to a slice of the 3D printed object. Repeating this sequence forms multiple slices that ultimately form the 3D printed object. In other words, the array (106) of lasers (108) selectively fuse portions of the layer of powdered build material in a particular pattern.

Rather than including a single laser moving across an entire build area, the additive manufacturing device (100) includes an array (106) of lasers (108), the array (106) being two-dimensional in some examples and including any number of lasers (108), including up to one million lasers (108). However, an array (106) with any number of lasers (108) may be used in conjunction with the present additive manufacturing device (100).

In some examples, the array (106) of lasers (108) is stationary and individually addressable. That is, during the fusing process, the lasers (108) coinciding or aligning with the 2D slice of a layer are activated to fuse the powdered build material at the same time, while those lasers (108) that do not coincide or align with the 2D slice are not activated. In other examples the array (106) of lasers (108) moves across the build area of the additive manufacturing device (100). In this example, the individual lasers (108) may still be individually addressable.

During fusing, the lasers (108) emit intense and focused energy. Application of the energy to the layer of powdered build material causes the powdered build material to absorb the energy and at least partially melt, which in turn causes at least some of the powdered build material to fuse or solidify into a layer of the 3D printed object being made. The lasers (108) can selectively emit pulses of laser light on a voxel by voxel basis to fuse all or a portion of the area that the lasers (108) pass over. The voxel relating to the operation of a laser (108) can be defined with reference to the width of its beam. As noted above, the property-changing agent distributed by the agent distributor (104) may be deposited on the layer of powdered build material before or after the powdered build material is fused by the lasers (108), or concurrently with the fusion by the lasers (108).

In some examples, an emitting energy of the lasers (108) corresponding to the pattern of property-changing agent are adjusted based on the property-changing agent. Although a property-changing agent is not meant to absorb energy, it may do so based on the ingredients of the property-changing agent. For example, a property-changing agent may have a cooling effect due to water in the agent. Accordingly, in this example, when this property-changing agent is placed on particular portions of the powdered build material, a higher energy is needed to fuse that area as opposed to other areas to be fused which do not include the property-changing agent.

As yet another example, the property-changing agent may change a melting point of the powdered build material. For example, a plasticizer may lower the melting point of PA-12 powdered build material. Accordingly, the power of the laser (108) is adjusted for this situation.

The lasers (108) may be of any desired type of any power output and wavelength range. While lasers (108) in the infrared region may be used, using lasers (108) with a shorter wavelength may be focused more precisely, whereby higher resolution of the 3D printed object may be possible. An energetic IR laser (108) (such as a CO₂ laser) may be used, for example. As specific examples, the lasers (108) may be any of, Nd:YAG lasers, Yb-doped fiber lasers, and excimer lasers. Using lasers to harden the material provides for an accurate and effective way to solidify portions of build material that is not as susceptible to thermal bleed as other forms of additive manufacturing. Accordingly, the present system (100) provides a system that provides for highly localized and accurate deposition of property-changing agents such that multi-property parts can be formed.

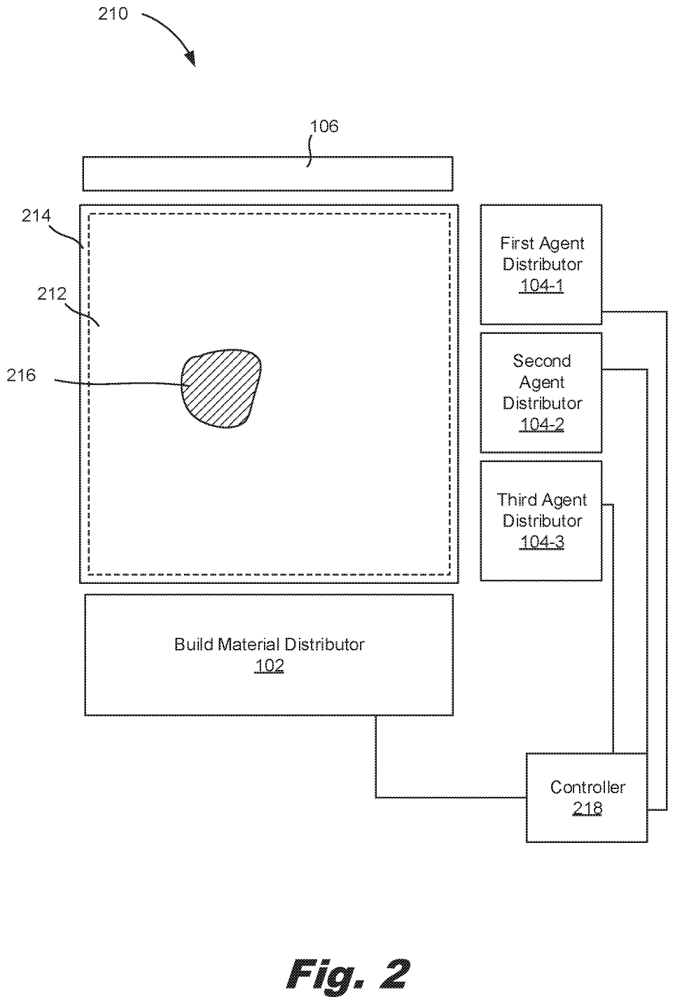

FIG. 2 is a simplified top view of an additive manufacturing system (210) with a laser array (106), according to an example of the principles described herein. In an example of an additive manufacturing process, a layer of build material may be formed in a build area (212). As used in the present specification and in the appended claims, the term “build area” refers to an area of space wherein the 3D printed object (216) is formed. The build area (212) may refer to a space bounded by a bed (214). The build area (212) may be defined as a three-dimensional space in which the additive manufacturing system (210) can fabricate, produce, or otherwise generate a 3D printed object (216). That is, the build area (212) may occupy a three-dimensional space on top of the bed (214) surface. In one example, the width and length of the build area (212) can be the width and the length of bed (214) and the height of the build area (212) can be the extent to which bed (214) can be moved in the z direction. Although not shown, an actuator, such as a piston, can control the vertical position of bed (214).

The bed (214) may accommodate any number of layers of powdered build material. For example, the bed (214) may accommodate up to 4,000 layers or more. In an example, a number of build material supply receptacles may be positioned alongside the bed (214). Such build material supply receptacles source the powdered build material that is placed on the bed (214) in a layer-wise fashion.

In FIG. 2 and others, the 3D printed object (216) is indicated in a patterned fill to distinguish the fused powder build material as compared to the raw powdered build material that surrounds it.

The additive manufacturing system (210) includes an additive manufacturing device (FIG. 1, 100) that includes a build material distributor (102) and multiple agent distributors (104-1, 104-2, 104-3). FIG. 2 clearly depicts the build material distributor (102). The build material distributor (102) may acquire powdered build material from build material supply receptacles, and deposit such acquired material as a layer in the bed (214), which layer may be deposited on top of other layers of powdered build material already processed that reside in the bed (214). In some examples, the build material distributor (102) may be a material coater, such as a hopper, a blade and/or a roller to dispense and spread the powdered build material.

In some examples, the build material distributor (102) may be coupled to a scanning carriage. In operation, the build material distributor (102) places build material in the build area (212) as the scanning carriage moves over the build area (212) along the scanning axis. While FIG. 2 depicts the build material distributor (102) as being orthogonal to the agent distributors (104), in some examples the build material distributor (102) may be in line with the agent distributors (104).

FIG. 2 also depicts the agent distributors (104). In the example depicted in FIG. 2, the additive manufacturing device (FIG. 1, 100) includes multiple agent distributors (104) to deposit multiple property-changing agents on layers of powdered build material in patterns. Each of the different agent distributors (104) may include different property-changing agents. For example, a first agent distributor (104-1) may distribute a plasticizing agent while a second agent distributor (104-2) distributes a hardening agent and the third agent distributor (104-3) distributes a transparency altering agent. While specific mention is made to particular property-changing agents, others may be implemented in accordance with the principles described herein.

Accordingly, the additive manufacturing system (210) can change multiple properties of the powdered build material, in some cases for a single layer. That is, after deposition of a layer of powdered build material, any combination and any number of the agent distributors (104) can operate to distribute their respective property-changing agent. As depicted in FIG. 2, the multiple agents may be deposited by different agent distributors (104) and in other examples, such as that depicted in FIG. 1, the multiple agents may be deposited by a single agent distributor (104) which is selectively coupled to different agent reservoirs.

In either example, the agent distributor(s) (104) may deposit different of the multiple property-changing agents in different patterns. That is, different portions of the 3D printed object (216) may receive different combinations of the multiple agents available for deposition on the 3D printed object (216).

In some examples, an agent distributor (104) includes at least one liquid ejection device to distribute a functional agent onto the layers of build material. A liquid ejection device may include at least one printhead (e.g., a thermal ejection based printhead, a piezoelectric ejection based printhead, etc.). In some examples, the agent distributor(s) (104) is coupled to a scanning carriage, and the scanning carriage moves along a scanning axis over the build area (212). In one example, printheads that are used in inkjet printing devices may be used as an agent distributor (104), In this example, the functional agent may be a printing liquid. In other examples, an agent distributor (104) may include other types of liquid ejection devices that selectively eject small volumes of liquid.

FIG. 2 also depicts the array (06) of lasers (FIG. 1, 108) that selectively fuses portions of the layer of powdered build material, again in a pattern. In some examples, the array (106) of lasers (FIG. 1, 108) is stationary. However, in other examples, such as that depicted in FIG. 2, the array (106) of lasers (FIG. 1, 108) move over the build area (212) of the additive manufacturing system (210). That is, in some examples the array (106) may be coupled to a scanning carriage. In operation, the lasers (FIG. 1, 108) in the array (106) fuse build material as the scanning carriage moves over the build area (212) along the scanning axis. While FIG. 2 depicts the array (106) in a particular resting position orthogonal to the agent distributors (104) and build material distributor (102), the array (106) may be in any particular resting position.

The additive manufacturing system (210) also includes a controller (218) to control the additive manufacturing. The controller (218) may include various hardware components, which may include a processor and memory. The processor may include the hardware architecture to retrieve executable code from the memory and execute the executable code. As specific examples, the controller as described herein may include computer readable storage medium, computer readable storage medium and a processor, an application specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the controller (218) cause the controller (218) to implement at least the functionality of depositing build material, depositing property-changing agents, and activating lasers (FIG. 1, 108) in the array (106).

Specifically, the controller (218) controls the build material distributor (102) to deposit layers of powdered build material. Further, the controller (218) may control the multiple agent distributors (104-1, 104-2, 104-3) to deposit the multiple property-changing agents in their respective patterns on the build material. The controller (218) also controls the array (106) of lasers (FIG. 1, 108). That is, the controller (218) passes a signal to the array (106) to activate certain of the lasers (FIG. 1, 108). As described above, each of the lasers (FIG. 1, 108) is individually-addressable such that the controller (218) may individually activate each laser (FIG. 1, 108). Specifically, a subset of the array (106) of lasers (FIG. 1, 108) may be activated which coincides with a slice of the 3D printed object (216).

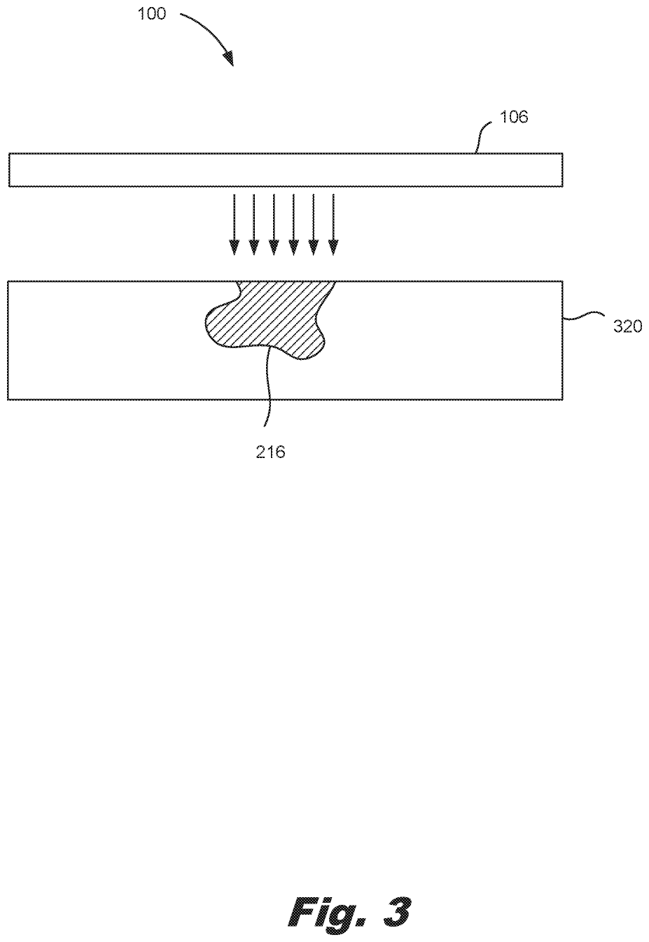

FIG. 3 is a side view of an additive manufacturing device (100) with a laser array (106), according to another example of the principles described herein. Specifically, FIG. 3 depicts the array (106) of lasers (FIG. 1, 108) as it is positioned over a build area (FIG. 2, 212) that contains a volume of build material (320) as well as the 3D printed object (216) formed therein. As described above, each laser (FIG. 1, 108) in the array (106) emits energy towards particular portions of the powdered build material (320) that corresponds to a slice of the 3D printed object (216) such that those portions that absorb the energy from the lasers (FIG. 1, 108) fuse together.

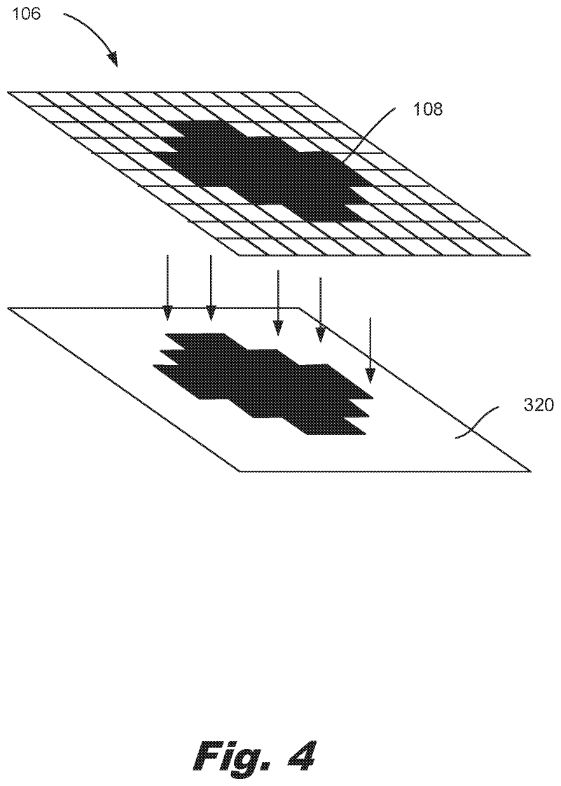

FIG. 4 is an isometric view of the laser array (106) over a build area (FIG. 2, 212) of an additive manufacturing device (FIG. 1, 100), according to an example of the principles described herein. In some examples, the array (106) may be two-dimensional and may overlay the entire area of the build area (FIG. 2, 212).

As described above, in some examples the array (106) moves over the surface of the build area (FIG. 2, 212) as depicted in FIG. 2. However, in other examples, the array (106) may be stationary over the build area (FIG. 2, 212) of the additive manufacturing device (FIG. 1, 100). In this example, a subset of the lasers (108) are activated, which subset coincides with a to-be-formed slice of the 3D printed part (FIG. 2, 216). For example, as depicted in FIG. 4, a layer of a 3D printed object (FIG. 2, 216) may have a particular cross-sectional area as depicted by the black boxes on the powdered build material (320) layer, A set of lasers (108) that corresponds to these black boxes are activated such that they emit fusing energy towards the powdered build material. This may be done as each laser (108) is individually addressable. That is, the controller (FIG. 1, 106) may activate just those lasers (108) that correspond to the particular pattern, which activated lasers (108) are depicted in FIG. 4 as black boxes in the array (106).

Those lasers (108) that do not correspond to the particular pattern of the slice of the 3D printed object (FIG. 2, 216), represented in FIG. 4 as white boxes in the array (106), may be entirely deactivated, i.e., not emitting. In some examples, the lasers (108) which do not coincide with the slice may be activated, but at a lower energy as compared to those lasers (108) which do coincide with the slice. Temperature differences across the build material (320) may have negative side-effects on the production of the 3D printed object (FIG. 2, 216).

Specifically, having a large temperature difference between the object area and the free powder area may cause large temperature differences between the 3D printed object (FIG. 2, 216) and the part boundary region, etc., which may result in part deformation, incomplete fusion, etc. Therefore, it may be the case that the temperature of the free powder area is kept just below the melting point for the powdered build material (320) and the temperature of the to-be-formed slices during the fusing process is kept just above the melting point of the powdered build material (320). This may be done in a number of ways, for example as described above by activating lasers (108) which do not coincide with the slice to a lesser degree. Accordingly, by maintaining other lasers (108) at a particular activation energy while allowing certain lasers (108) to have a higher, and fusing, activation energy, provides a more consistent thermal gradient across the surface of the build material (320) layer, thus reducing the negative effects of increased thermal differences. In another example, an overhead infrared lamp could be used to heat up the entire layer to close to the melting point, and then use the corresponding lasers (108) to heat up the area that is to form the slice to just above the melting point.

Note that as each slice of the 3D printed object (FIG. 2, 216) may have a different cross-section, different subsets of lasers (108) may be activated for each layer of powdered build material (320) that is deposited. Accordingly, such a stationary multi-laser array (106) reduces the amount and complexity of additive manufacturing device (FIG. 1, 100) components.

Moreover, note that while FIG. 4 depicts a certain number and size of lasers (108) in the array (106), these components have been enlarged for illustration purposes, and an array (106) may include any number of lasers (108). For example, the array (106) may include one million lasers (108),

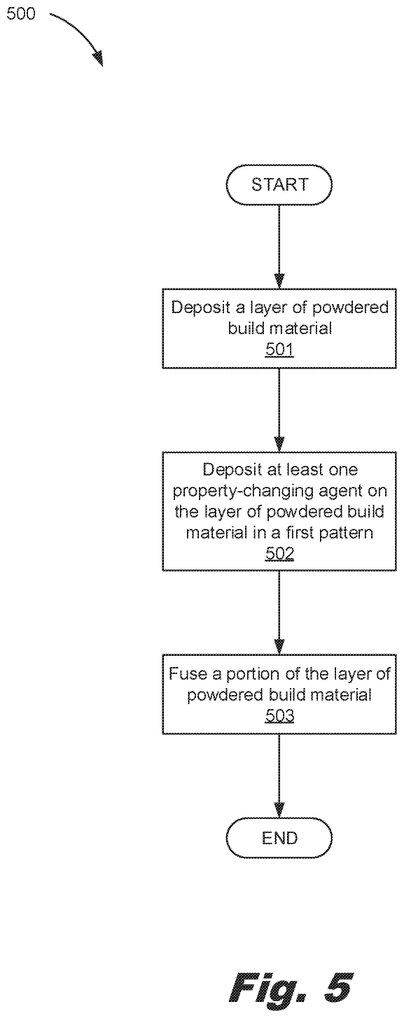

FIG. 5 is a flow chart of a method (500) for additive manufacturing with a laser array (FIG. 1, 106), according to an example of the principles described herein. As described above, additive manufacturing involves the layer-wise deposition of powdered build material (FIG. 3, 320) and sintering of certain portions of that layer to form a slice of a 3D printed object (FIG. 2, 216). Accordingly, in this example, the method (500) includes depositing (block 501) a layer of powdered build material (FIG. 3, 320), This includes sequential activation, per slice, of a build material distributor (FIG. 1, 102) and the scanning carriages to which it may be coupled so that it distributes the build material (FIG. 3, 320) across the surface of the bed (FIG. 2, 214).

Following deposition (block 501) of a layer of powdered build material (FIG. 3, 320), at least one property-changing agent is deposited (block 503) on the layer in a predetermined pattern. As described above, the property-changing agent may be of a variety of types. Moreover, as described above, multiple property-changing agents may be deposited, each in the same or different patterns. Such a deposition may be by inkjet printheads such as a thermal inkjet printhead or a piezoelectric inkjet printhead. Similar to the build material distributor (FIG. 1, 102), the agent distributor(s) (FIG. 1, 104) may be coupled to a scanning carriage such that they are moved over the layer of powdered build material and the property-changing agent therein deposited in a particular pattern. Using inkjet printheads facilitates highly accurate deposition of corresponding agents, which allows for high resolution of a resulting multi-property 3D printed object (FIG. 2, 216).

A portion of the layer of powdered build material (FIG. 3, 320) is then fused (block 503) to form a slice of the 3D object (FIG. 2, 216). Such fusion may be done by selectively activating a subset of lasers (FIG. 1, 108) in the array (FIG. 1, 106) of lasers (FIG. 1, 108) that coincides with the slice. That is, as discussed above, the fusing lasers (FIG. 1, 108) emit energy on the powdered build material (FIG. 3, 320), which raises the temperature of the build material (FIG. 3, 320) and causes the build material (FIG. 3, 320) to fuse together or solidify.

In some examples, fusing (block 503) a portion of the layer of powdered build material (FIG. 3, 320) occurs before deposition (block 502) of the at least one property-changing agent. An example of this scenario is indicated in FIGS. 7A-7D. In another example, fusing (block 503) a portion of the layer of powdered build material (FIG. 3, 320) occurs after deposition (block 502) of the at least one property-changing agent. An example of this scenario is indicated in FIGS. 6A-6D. In yet another example, fusing (block 503) a portion of the layer of powdered build material (FIG. 3, 320) occurs concurrently with deposition (block 502) of the at least one property-changing agent.

FIGS. 6A-6D depict additive manufacturing with laser arrays (FIG. 1, 106), according to an example of the principles described herein. Specifically, FIGS. 6A-6D depict a scenario where the agent distributor (FIG. 1, 104) deposits the property-changing agent before fusing of the build material (320). In FIG. 6A, at least one layer of the 3D printed object (216) has been formed. That is, it is has already been fused. Accordingly, a new layer is formed by activating the build material distributor (FIG. 1, 102) to lay down a layer of powdered build material (320) over the fused portion of the 3D printed object (216).

Then as depicted in FIG. 6B, a property-changing agent (622) may be deposited on the powdered build material (320). The property-changing agent (622) is absorbed into the powdered build material (320) to define a property-changed zone (624). As depicted in FIG. 6C, the lasers (FIG. 1, 108) of the array (FIG. 1, 106) are activated to emit energy, indicated by the arrows (626), to partially melt and bind the powdered build material (320) directly underneath the lasers.

Once heat is removed, i.e., the lasers (FIG. 1, 108) are de-activated, a new layer of the 3D printed object (216) results, at least part of which has a property-changed zone (624) due to deposition of the property-changing agent thereon.

FIGS. 7A-7D depict additive manufacturing with laser arrays (FIG. 1, 106), according to an example of the principles described herein. Specifically, FIGS. 7A-7D depict a scenario where the agent distributor (FIG. 1, 104) deposits the property-changing agent after fusing of the build material (320). In FIG. 7A, at least one layer of the 3D printed object (216) has been formed. That it, is has already been fused. Accordingly, a new layer is formed by activating the build material distributor (FIG. 1, 102) to lay down a layer of powdered build material (320) over the fused portion of the 3D printed object (216).

As depicted in FIG. 7B, the lasers (FIG. 1, 108) of the array (FIG. 1, 106) are activated to emit energy, indicated by the arrows (626), to partially melt and bind the powdered build material (320) directly underneath the lasers (FIG. 1, 108).

Then, as depicted in FIG. 7C, a property-changing agent (622) may be deposited on the fused powdered build material (320). The property-changing agent (622) as absorbed into the fused powdered build material to define a property-changed zone (624).

Once agent deposition is complete, a new layer of the 3D printed object (216) results, at least part of which has a property-changed zone (624) due to deposition of the property-changing agent thereon.

Such systems and methods 1) provide for powder-based multi-property additive manufacturing, 2) change material properties at a per-voxel resolution, and 3) fuse individual layers of a 3D printed object. However, it is contemplated that the systems and methods disclosed herein may address other matters and deficiencies in a number of technical areas.

What is claimed is:

1. An additive manufacturing device, comprising:
a build material distributor to deposit layers of powdered build material onto a bed;
an agent distributor to deposit at east one property-changing agent in a pattern onto a layer of powdered build material; and
an array of lasers to selectively fuse portions of the layer of powdered build material in a pattern.

2. The additive manufacturing device of claim 1, wherein the array of lasers is stationary over a build area of the additive manufacturing device.

3. The additive manufacturing device of claim 1, wherein the array of lasers moves over a build area of the additive manufacturing device.

4. The additive manufacturing device of claim 1, wherein:
the array of lasers is formed in a two-dimensional array; and
each laser of the array of layers is individually addressable.

5. The additive manufacturing device of claim 1, wherein an emitting energy of the lasers corresponding to the pattern of property-changing agent are adjusted based on the property-changing agent.

6. The additive manufacturing device of claim 1, wherein the agent distributor is to deposit at least one of:
an electrical property-changing agent;
a plasticizing agent;
a hardening agent; and
a transparency property-changing agent.

7. The additive manufacturing device of claim 1, wherein the agent distributor is to deposit multiple property-changing agents.

8. The additive manufacturing device of claim 7, wherein the agent distributor is to deposit different of the multiple property-changing agents in different patterns.

9. A method, comprising:
depositing a layer of powdered build material;
depositing, in a predetermined pattern, at least one property-changing agent on the layer of powdered build material; and
fusing a portion of the layer of powdered build material to form a slice of a three-dimensional (3D) printed object by selectively activating a subset of lasers in an array of lasers.

10. The method of claim 9, wherein the subset of lasers coincide with the slice of the 3D printed object.

11. The method of claim 9, wherein fusing a portion of the layer of powdered build material occurs before deposition of the at least one property-changing agent.

12. The method of claim 9, wherein fusing a portion of the layer of powdered build material occurs after deposition of the at least one property-changing agent.

13. The method of claim 9, wherein fusing a portion of the layer of powdered build material occurs concurrently with deposition of the at least one property-changing agent.

14. An additive manufacturing system, comprising:
an additive manufacturing device comprising:
a build material distributor to deposit layers of powdered build material onto a bed;
multiple agent distributors to deposit multiple property-changing agents on layers of powdered build material in patterns; and
an array of lasers to selectively fuse portions of the layer of powdered build material in a pattern; and
a controller to:
control the build material distributor to deposit layers of powdered build material;
control the multiple agent distributors to deposit the multiple property-changing agents in their respective patterns on the layers of the powdered build material; and
control the array of lasers to activate a subset of lasers which coincide with a slice of a three-dimensional (3D) printed object.

15. The additive manufacturing system of claim 14, wherein lasers which do not coincide with the slice are activated at a lower energy than the subset.
